(19) United States
(12) Patent Application Publication
(10) Pub. No.: US 2013/0338914 A1
(43) Pub. Date: Dec. 19, 2013

(54) SYSTEM AND METHOD FOR NOTIFYING VEHICLE DRIVER OF LOCALIZED DRIVING CONDITIONS

(71) Applicant: Andrew Weiss, San Ramon, CA (US)

(72) Inventor: Andrew Weiss, San Ramon, CA (US)

(73) Assignee: WAVEMARKET INC., Emeryville, CA (US)

(21) Appl. No.: 13/523,025

(22) Filed: Jun. 14, 2012

(51) Int. Cl. G08G 1/0967; G08B 21/02; G01C 21/26

(52) U.S. Cl. 701/465; 340/905

(57) ABSTRACT

A driving assessment system and method is described that automatically assesses driving conditions around a driver to identify safety hazards and to subsequently inform that driver when an unusually hazardous condition exists. The driving assessment is performed by obtaining and storing safety related data from the driver and from external sources and then processing that data in real time to produce a driving hazard assessment and warning. Beneficially the driving hazard assessment automatically obtains and considers existing conditions of the road system local to the driver.

### FIELD OF INVENTION

This invention relates to driving safety. More particularly, this invention relates to analyzing the local driving conditions around drivers, to assess driving safety and to inform drivers when hazardous driving conditions exist.

### BACKGROUND

Among the driving population are a large number of drivers who may benefit from active monitoring and assessment of their driving and their driving environment to detect and warn about dangerous driving situations. For example, active monitoring and assessment might be particularly beneficial to young drivers, new drivers, drivers hauling or carrying dangerous materials, drivers driving in unknown or dangerous locales, and drivers with a history of road rage, driving under the influence of drugs or alcohol, speeding, or other reckless operations.

All drivers, even those who actively practice driver safety face a range of challenges to safe driving. For example, existing road conditions around a driver, such as potholes, sharp curves, multi-way stops, animal crossings, road construction, poor roads, and factors resulting in a higher accident rate along a particular road can result in safety issues. Weather conditions, such as rain, snow, ice, fog, and conditions that cause black ice also create driving safety issues. In addition, the time of driving such as nighttime driving or driving while facing a setting or rising sun also create driving safety issues.

A driver must also contend with issues specific to himself or herself. For example, the make, model, age, mileage, design defects, recall history, prior accident history, brakes, and tire condition of the driver's vehicle may be a relevant with respect to driving safety. Further, a driver's driving history may be indicative of heightened driving risks, particularly past speeding tickets, driving while intoxicated arrests and convictions, and reckless operation citations. A driver's history of alcohol or drug use, history of smoking, gender, age, medical conditions such as narcolepsy, and a history of aggressiveness can also be factors in assessing driving risk.

Another potential detriment to safe driving is other drivers. Very few drivers have the luxury of driving along completely deserted roads, thus the other drivers can present safety issues. Each of the other drivers has the same personal safety issues identified in the previous paragraphs. In fact, defensive driving is based on taking steps to reduce problems created by “the other guy.” For example, if another driver is weaving or otherwise driving recklessly, a safe driver will recognize that situation and take steps to avoid an accident.

Assessing the impact of the foregoing issues, and other unmentioned issues affecting safe driving, is a difficult task perhaps attempted by a driver based on training and past driving experience. At times a knowledgeable passenger or highway safety warnings may help a driver assess unsafe conditions. However, knowledgeable passengers and highway safety warnings are not always available, not all drivers have the proper training and driving experience to adequately assess driving safety issues, and even those that do sometimes become distracted, otherwise fail to properly assess driving conditions, or simply are unaware that a dangerous condition exists.

A system for automatically assessing driving safety hazards and subsequently informing a driver of the existence of an unusually hazardous condition would be beneficial.

### SUMMARY

The invention automatically assesses driving conditions around a driver to identify safety hazards and subsequently informs that driver when an unusually hazardous condition exists. The driving assessment is performed by obtaining and storing safety related data from the driver and from external sources and then processing that data in real time to produce a driving hazard assessment and warning. Beneficially the driving hazard assessment automatically obtains and considers existing conditions of the road system local to the driver. In the event of an assessed safety hazard, a warning is sent to a driver so that he can take steps to avoid the hazard.

According to one aspect the invention is a system comprising an application running on a mobile device, in communication with a centralized computer server that accesses the current location of a first user's mobile device, accesses environmental data at the current location; generates a driving condition assessment based on the current location and environmental data; and provides a driving condition assessment to the first user. That driving condition assessment beneficially comprises a risk assessment that corresponds to the physical road conditions on which the first user is traveling. Such risk assessment includes considering a pothole, a curve, an intersection, an animal crossing, road construction, and/or the existence of an elevated auto accident contiguous with the current location. Preferably the environmental data includes the current weather conditions such rain, ice, snow, fog, sleet, lightning, hail, time of day, sunrise, sunset, and/or ambient light. The method beneficially analyzes information related to a second driver and, if appropriate, sends the first driver a notification about a safety hazard created by a second driver.

The system beneficially accesses descriptive data of a motor vehicle corresponding to the first user and then uses that descriptive data to generate the driving condition assessment. The motor vehicle descriptive data includes the motor vehicle make, model, age, mileage; known design defects, maintenance history, tire age and/or tire mileage. That method may also access and use the current speed data of the mobile device corresponding to the first user when generating the driving condition assessment. The method can also determine the speed limit on the road corresponding to the first user, compare the current speed data of the first user with the speed limit, and generate the driving condition assessment based on that comparison. Beneficially, the processor based method also accesses the driving history data corresponding to the first user then generates the driving condition assessment further based on that driving history data.

The method can also determine the speed data for all vehicles accessible by the system at a given road location at a given time, to determine the average speed of traffic for vehicles at that road location at that time. This average speed may in fact be considerably higher than the posted speed limits for that road location. Beneficially, the processor based method accesses the location, time and driving speed of the vehicle of the first user, and compares it to the derived average speed of vehicles at that location to determine if the vehicle is moving at a speed in excess of that average, or significantly below that average.

The system benefits from accessing sensor data available from the mobile device, assessing the driving skill level of the first user based on the accessed sensor data, and then generating the driving condition assessment based on the assessed driver's skill level. Beneficially the sensor data includes location data such as GPS data or cell site interpolation data and acceleration data that can be used to determine velocity and acceleration.

The system further benefits from accessing and using map data corresponding to the predetermined location data when assessing the user's skill level. Furthermore, the map data includes one or more indications of traffic intersections, indications of traffic signs, indications of traffic signals, indications of road directional restrictions, indications of lane configurations, and indications of traffic intersections. In practice assessing the user's skill includes assessing whether the first user adheres to the driving rules by comparing the sensor data and the map data. The processor implemented method can further assess when generating the driving condition assessment at least one of a gender of the first user, an age of the first user, and an indication of the health of the first user.

The system preferably accesses current location data of a mobile device corresponding to a second user, compares the current location data of the mobile device corresponding to the first user and the current location data of the mobile device corresponding to the second user; and generates the driving condition assessment further based on comparing the current location data of the mobile device corresponding to the first user with the current location data of the mobile device corresponding to the second user. Further, driving history data corresponding to the second user is accessed and used when generating the driving condition assessment.

Sensor data from the mobile device of the second user is also accessed and used to predict a driver skill level for the second user, and that driver skill level for the second user is used to generate the driving condition assessment. That sensor data beneficially includes one or more of the current location data, current velocity data, current acceleration data which corresponds to the second user. The sensor data is then used to apply a classifier to the current sensor data corresponding to the second user which is used when generating the driving condition assessment.

The system further includes accessing current sensor data comprising the current location data and at least one of current velocity data and current acceleration data corresponding to the first user, accessing current sensor data comprising the current location data and at least one of current velocity data and current acceleration data corresponding to the second user, and determining, based on the current sensor data corresponding to the first and second users whether that the second user is on a trajectory corresponding to a prospective future location of the first user, and then generating the driving condition assessment further based on the determined trajectory.

The system can also determine from the current sensor data corresponding to the second user that the second user is driving in an unsafe manner. The determination that the second user is driving in an unsafe manner is then used when generating the driving condition assessment. The driving history data corresponding to the second user is also accessed and based on that driving history data a determination is made whether second user is an unsafe driver risk. If the second user is an unsafe driver risk that assessment is used when generating the driving condition assessment. The system further comprises producing a classifier based on predetermined sensor data specific to a type of vehicle driven by the second user, accessing current sensor data corresponding to the second user, including the phone location finder (phone GPS, cell site interpolation, etc.) to determine velocity of the second user and phone accelerometer to dynamically classify the driving state of the second user, and using the classifier when generating the driving condition assessment.

According to another aspect the invention is driving hazard assessment and warning system in which an intended mobile device having communications capabilities produces intended user location data that corresponds to a location in a road description database. A computer server receives the intended user location data, accesses the road description database, analyzes the road to identify a substantial safety hazard, and produces an alert using an alert subsystem if the computer server identifies a substantial safety hazard. That alert is then sent to the intended mobile device.

The driving hazard assessment and warning system also analyzes weather data, such as from a weather database, driver information about the intended user from a driver database, and intended user vehicle information from a vehicle database to identify a substantial safety hazard. The driving hazard assessment and warning system creates a driver classification database, populates that driver classification database with at least one classification of the intended user, and uses the driver classification database to identify a substantial safety hazard. At least one classification of the intended user is that the intended user is prone to speeding, drunk driving, driving while distracted, reckless driving, running red lights, running stop signs, driving the wrong direction, unsafe lane changes, tailgating, improper turns, road rage, drowsy driving, and street racing.

Beneficially the road description database includes data corresponding to at least one of the following: a pothole, a sharp curve, a multi-way stop, an animal crossing, road construction, and a high accident rate, while the weather data includes data corresponding to at least one of the following: rain, ice, snow, fog, time of day, sunrise time, sunset time, sleet, ambient light, and location of rising/setting sun. Such road description information can be sent directly to the user to assist driving. Also beneficially the vehicle database includes data corresponding to at least one of the following: make, model, age, mileage, design defects, tire age, and tire mileage of the intended vehicle, while the driver database includes data corresponding to at least one of the following: age of the intended user, gender of the intended user, health of the intended user, tobacco usage, alcohol usage, drug usage of the intended user.

Preferably the driving hazard assessment and warning system further includes a second mobile device having communications capabilities which produces second user location data that corresponds to a second road. The system receives and analyzes the second user location data to determine if the second user presents a substantial safety hazard, such as a substantial crash hazard. Beneficially the system uses the second mobile device to obtain and analyze a description of the second vehicle from the vehicle database to identify a substantial safety hazard. The driving hazard assessment and warning system also uses second user data that includes at least one of the following: age of the second driver, gender of the second driver, health of the second driver, tobacco usage, alcohol usage and drug usage of the second driver to identify a substantial safety hazard. The driver classification database also contains at least one classification of the second user, such as that the second user is prone to speeding, drunk driving, driving while distracted, reckless driving, running red lights, running stop signs, driving the wrong direction, unsafe lane changes, tailgating, improper turns, road rage, drowsy driving, and street racing. The location finder and accelerometer on the phone of the second driver are accessed, this data is input to a classifier, and a determination is made of whether the second driver is driving in an unsafe manner, through one of speeding, weaving in traffic, rapid changes in acceleration/deceleration, lane drifting, etc. The system uses at least one classification of the second driver to identify a substantial safety hazard. The first mobile device is notified of any safety hazard created by the second user.

### BRIEF DESCRIPTION OF THE DRAWING(S)

The foregoing Summary as well as the following detailed description will be readily understood in conjunction with the appended drawings which illustrate embodiments of the invention. In the drawings:

FIG. 1 is a depiction of a prototypical context in which the invention is practiced;

FIG. 2 illustrates a simplified communication network for the context shown in FIG. 1;

FIG. 3 provides a schematic topology of the functional components of the invention;

FIG. 4A presents a flow diagram of part of the functional operation of the invention;

FIG. 4B presents a flow diagram of another part of the functional operation of the invention;

FIG. 4C presents a flow diagram of yet another part of the functional operation of the invention; and

FIG. 4D presents a flow diagram of yet another part of the functional operation of the invention.

### DETAILED DESCRIPTION OF ILLUSTRATIVE EMBODIMENT(S)

While embodiments of the invention have been described in detail above, the invention is not limited to the specific embodiments described above, which should be considered as merely exemplary. Further modifications and extensions of the invention may be developed, and all such modifications are deemed to be within the scope of the invention as defined by the appended claims.

In the figures like numbers refer to like elements. Furthermore, the terms “a” and “an” as used herein do not denote a limitation of quantity, but rather denote the presence of at least one of the referenced items. Any and all documents and references referred to herein are hereby incorporated by reference for all purposes.

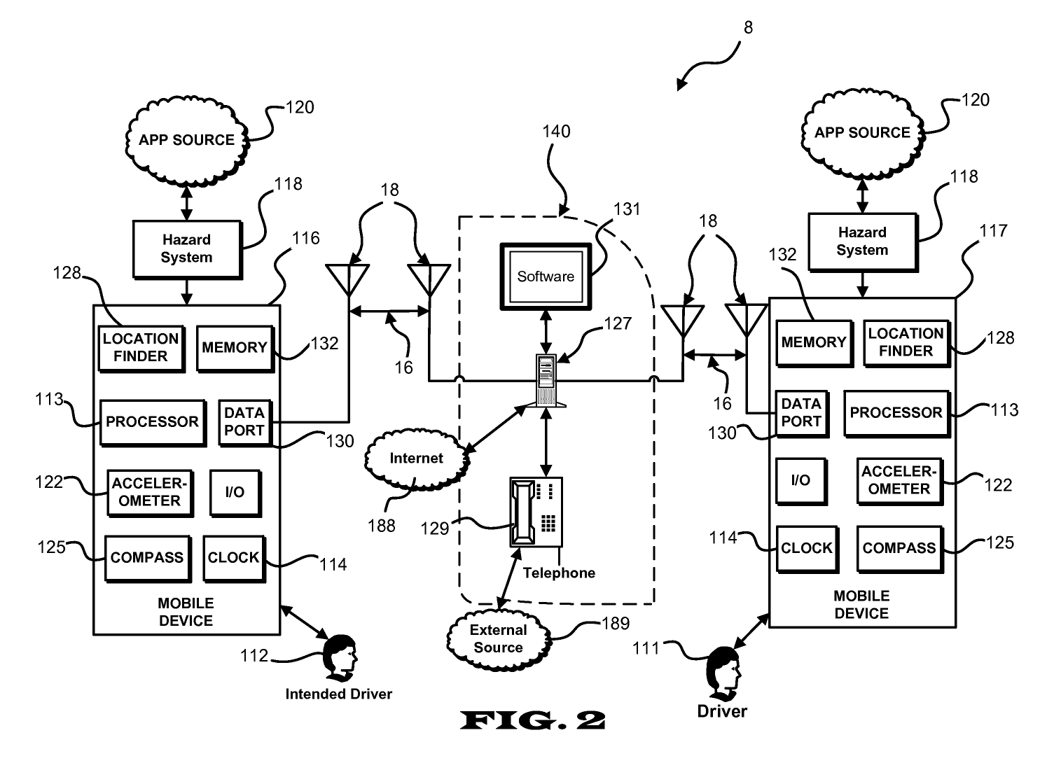

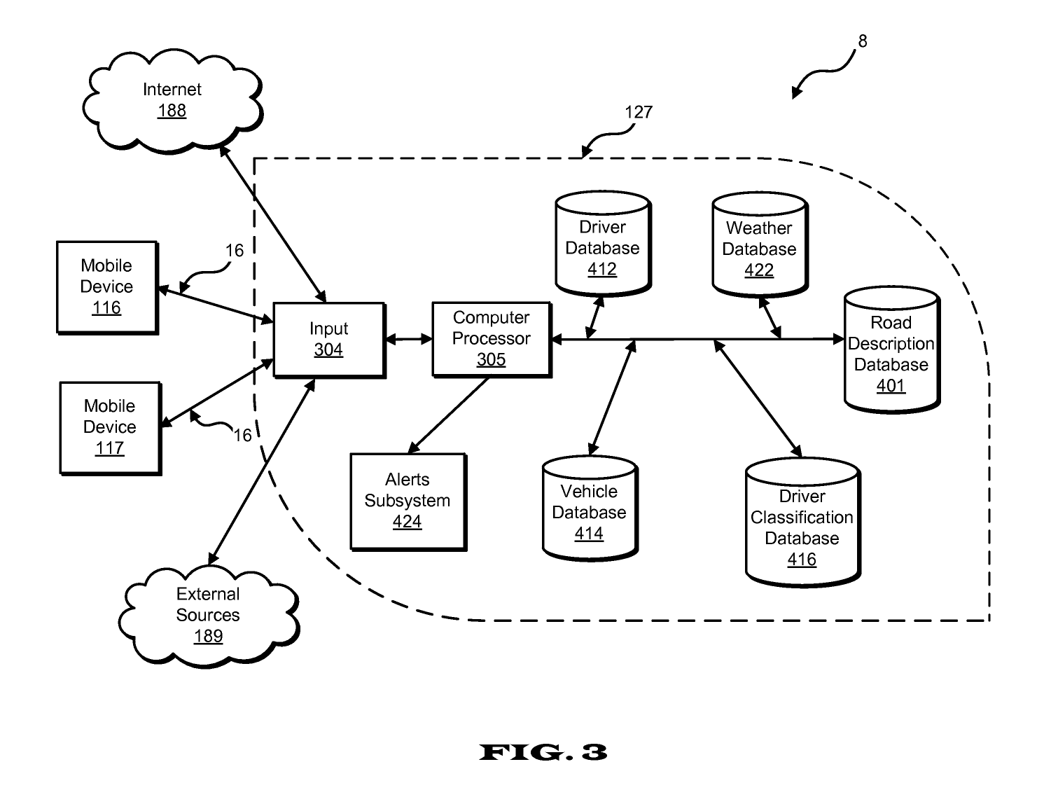

The illustrated embodiment of the invention implements an automated, real time driving hazard assessment and warning system 8 (referenced in FIGS. 2 and 3) for improving driver safety by producing a warning when driving is determined to be hazardous. Beneficially, the driving hazard assessment and warning system 8 gathers a range of safety related data from internal and external sources, including data related to other drivers, analyzes that data to produce an assessment of driving safety, and provides a real time warning if the assessment determines that a significant driving hazard exits.

Driving safety related data includes (if available) road conditions, weather conditions (including the time of day), the condition of the driver's vehicle, the condition of operating vehicles around the driver, the existence of one or more driver distractions, driver history, the driving history of surrounding drivers, driver characterizations, speed, heading, and detected operational factors such as current reckless driving or tailgating.

A significant driving hazard is a condition or set of conditions that impair driving safety such that a prudent driver would wish to be informed. While reasonable drivers may differ on how much driving safety must be impaired to be classified as a hazardous condition, in practice that level will be set by a system designed to achieve the overall goals of the specific implementation.

The driving hazard assessment and warning system 8 uses at least one mobile device and a computer-based server to achieve the goals of the driving hazard assessment and warning system 8. A processing system 140 (see FIG. 2) acts as a central server which interacts with the mobile devices and provides most of the processing power and memory required to implement the hazard assessment and warning system 8.

The processing system 140 has the effect of minimizing the amount of processing that will need to occur on each mobile phone, and of centralizing data collection, such as local weather conditions, road hazard information, etc., as well as data analysis, such as deriving the relative risk imposed by a second user on that of a first user.

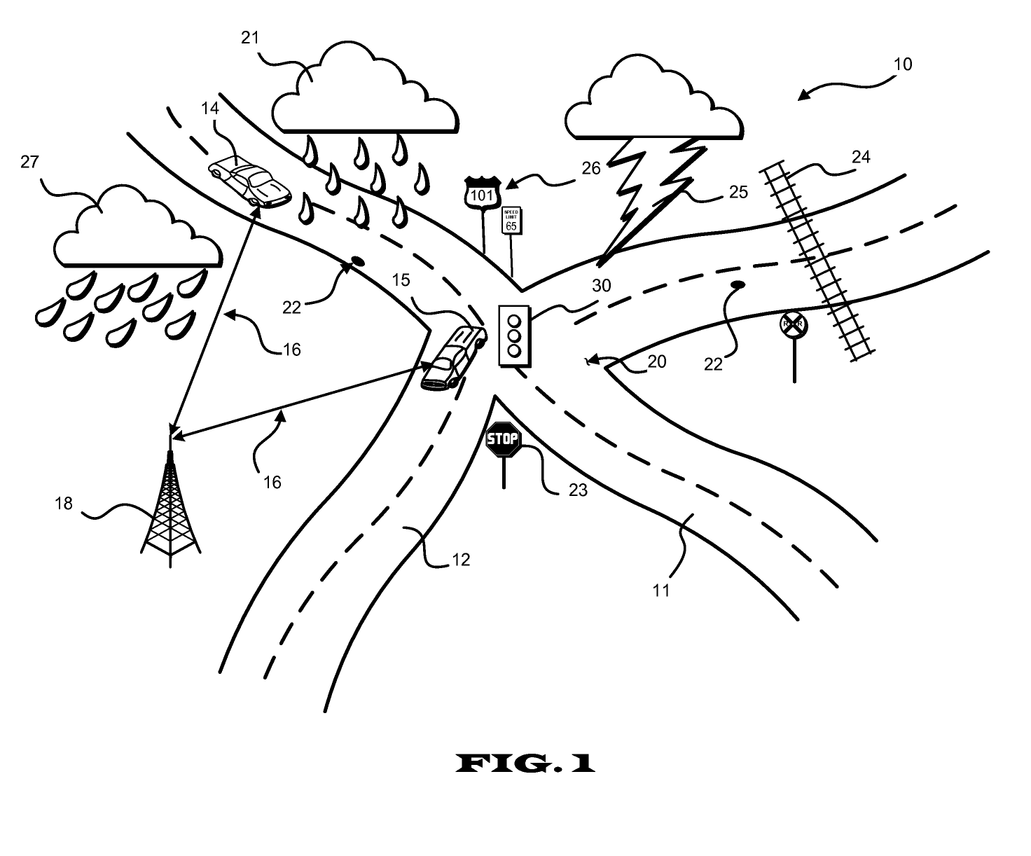

FIG. 1 illustrates a prototypical context 10 in which a driver benefits from the hazard assessment and warning system 8. As shown that context 10 includes crossing roads 11, 12 that are traversed by an intended vehicle 14 and a vehicle 15. The intended vehicle 14 is driven by an intended driver 112 (shown in FIG. 2), which is the driver benefiting from the hazard assessment and warning system 8. The vehicle 15 has a driver 111 (also see FIG. 2). In FIG. 1 the intended driver 112 carries a mobile device 116, while the driver 111 carries a mobile device 117 (referenced in FIGS. 2 and 3).

The distinction between the intended driver 112 and the driver 111 is solely used to simplify the description of the hazard assessment and warning system 8. Because the hazard assessment and warning system 8 protects more than one driver, the driver 111 might also benefit. But for clarity of explanation the intended driver 112 and the items associated with him are distinguished from the driver 111 and his items.

The intended driver 112 is one particular driver. Since the mobile device 116 can be used by several different drivers, the mobile device 116 is programmed with a driver identification function in which drivers sign in as the intended driver 112. This enables one mobile device 116 to support multiple drivers. If the driver associated with a mobile device is known, then no such sign in is necessary. Also, it is not necessary for a driver to be identified to the system. It may be possible to implicitly deduce the identity of a driver based on that driver's behavior. In the event that it is not possible to identify the driver of the vehicle, all other aspects of the system that are other than related to knowing the identity of the driver are applicable.

As may be appreciated from understanding the invention, the hazard assessment and warning system 8 is well suited for use with robot operated vehicles. As such, the intended driver 112 and the intended vehicle 14 merge. The hazard assessment and warning system 8 can then functionally integrate with other systems that operate the robot-operated vehicle. For example, a warning from the hazard assessment and warning system 8 could cause the robot-operated vehicle to automatically slow down or take other evasive actions.

Still referring to FIG. 1, the context 10 presents a plurality of safety-related factors assessed by the hazard assessment and warning system 8. Those factors include a multi-way intersection 20, wind-driven rain 21 turning to sleet 27, pot holes 22, a warning (Stop) sign 23, railroad tracks 24 (with warning sign), lightning 25, multiple road signs 26 very close together, a stop light 30, the two vehicles 14, 15 whose condition (including tires and brakes) may create a heightened safety risk, and the drivers 112, 111. Note that the vehicle 15 is crossing the intersection 20 while traveling on the wrong side of the road 12.

It should be understood that the context 10 is simplified and an actual operating context may have other factors, such as snow, hail, ice, fog, many vehicles and drivers, sharp curves, animal crossings, road construction, and visual obstructions. These factors, as well as others, will produce an accident rate along the roads 11, 12. Ideally all of those factors, as well as the accident rate are considered by the hazard assessment and warning system 8.

In FIG. 1 it should be understood that the intended vehicle 14 and the vehicle 15 are moving, accelerating, turning, and weaving. One or both of those vehicles may have an identified design defect (such as a history of recalls) or may have been involved in a prior accident that, if not properly repaired, could create a safety hazard. One or both drivers 112, 111 may have a history of dangerous vehicle operation (tickets, license suspensions, citations) or a medical condition such as narcolepsy, epilepsy, or diabetes that may create a driving safety hazard. The hazard assessment and warning system 8 obtains data related to those (and other) safety related factors from both internal and external sources.

Still referring to FIG. 1, each vehicle 14, 15 is at a specific location while traveling at a certain speed along its respective road 11, 12. As the vehicles 14, 15 travel, their positions, headings, and speeds vary, as do the potential safety hazards encountered. Referencing FIGS. 2-4, the mobile devices 116, 117 have both established bi-directional communications with the processing system 140 over a communication path 16 that is provided by a cellular communication system 18, which is represented by the tower in FIG. 1 and by antennas in FIG. 1. Thus the processing system 140 has communications with both of the mobile devices 116, 117.

The mobile devices 116, 117 incorporate fast, powerful processors and other semiconductor devices such as very large scale integrated (VLSI) chips and supporting components such as resistors, inductors, capacitors, and antennas. They operate in accord with an underlying operating system and more specialized application software (“Apps”) that implement special features. In particular, the mobile devices 116, 117 are operating in accord with an App, referred to herein as a hazard system 118 that supports the needs of the hazard assessment and warning system 8. In addition, the mobile devices 116, 117 can receive and process global positioning system (GPS) signals or other location-determining signals that enable accurate position sensing which is then sent to the processing system 140. The global positioning system (GPS) is an existing and widely used infrastructure operated by the United States Government. Alternately, the mobile device 116 can communicate with the processing system 140. The processing system 140 can then communicate with the mobile device 117.

Either way the processing system 140 uses the data sent to it by the mobile devices 116, 117, assesses the driving hazards faced by the driver 112 with available data, and if a hazardous driving situation is detected for the driver 112, that driver is notified of the situation.

Referring to FIG. 2, the hazard system 118 is a software application that configured to provide the hazard assessment and warning system 8 with features available from the mobile device 116. Those features include providing data from the mobile device sensors, specifically including data from a location finder 128, an accelerometer 122, and if present a compass 125. The data from the location finder 128 is processed by the hazard system 118 to determine the intended vehicle's 14 location, speed and acceleration, while the data from the compass 125, if present, is used to determine the intended vehicle's 14 heading. If a compass 125 is not present or used the heading information can be obtained from the location finder 128, for example via GPS signals, at different times.

The hazard system 118 further supports establishing the communication link 16 and enables the mobile device 116 to send and obtain data, retrieve and store information in memory, and make any required settings of the mobile device 116 to perform its programmed task(s). In particular, the hazard system 118 automatically interacts with the processing system 140. In some systems the mobile device 116 performs at least part of the hazard analysis using information sent by the processing system 140 to the mobile device 116. For example, if the processing system 140 notices that the driver 111 is a hazard, the processing system sends that information to the mobile device 116. The hazard system 118 then provides a warning to the driver 112 regarding the hazard. Alternatively, the mobile device 116 may perform part of the hazard analysis using information derived from the sensors on the mobile device 116, including one or more of the location finder 128 (e.g. GPS), accelerometer 122, and compass 125. This sensor data preferably acts as input to a classifier, which derives a hazardous driving state for the driver 111.

FIG. 1 presents the context 10 of the hazard assessment and warning system 8 and the capabilities of the mobile devices 116, 117. FIG. 2 presents a simplified depiction of the overall hazard assessment and warning system 8, which includes the mobile devices 116, 117, the communication link 16, and the processing system 140 having a computer 127 with access to the internet 188 and other external sources 189. The communication system 18 connects the intended driver 112 in the intended vehicle 14 and the driver 111 in the vehicle 15 (see FIG. 1) to the processing system 140 (but not necessarily directly to each other). As noted, the intended driver 112 carries the processor 113-based mobile device 116 operated in accords with the hazard system 118, which is beneficially downloaded from an app source 120, or may have been pre-installed on the mobile device 116. An example of the foregoing is a younger driver (the intended driver 112) who has been given a cell phone (the mobile device 116) by a parent and who has downloaded and installed the hazard system 118 from a phone store (the app source 120) with the intent of improving driver safety by joining the hazard assessment and warning system 8.

The processing system 140 includes the computer 127 that operates in accord with operational software 131. The operational software 131 integrates data gathering capabilities that in FIG. 2 are represented by a link to the internet 188 and by a telephone 129 which enables data communications with other remote entities 189. The operational software 131 causes the computer 127 to use the telephone 129, the internet 133, and the communication links 16 to automatically obtain safety-related data from internal sources, such as data in the mobile devices 116, 117 and data stored internally in the computer 127, and remote sources (explained in more detail subsequently) as required to carry out the goal of the hazard assessment and warning system 8.

The computer server 127 has permanent memory that stores data required to run the hazard assessment and warning system 8. Some of that data, including current location, heading, and acceleration is obtained from the mobile devices 116, 117. As described in more detail subsequently, the computer server 127 also stores learned information, including information acquired in the form of classifiers. The hazard assessment and warning system 8 can learn by training and storing one or more such classifiers, for example one or more classifiers related to safety faults that the intended driver 112 is prone to. Those driving faults can be learned over time such as whether the intended driver 112 tends to speed, drive recklessly, run red lights, run stop signs, make unsafe lane changes, drive the wrong way along one-way streets, make improper turns, tailgate, be subject to road rage, participate in street racing, or drive while intoxicated or when drowsy.

A nonexclusive list of other safety-related data obtained by the computer server 127, and stored in its permanent memory, includes information about the physical condition of the roads 11, 12 around the intended driver 112 and the driver 111, such as pothole and road construction information, and accident rates along localized areas of the roads 11, 12 (available for example from the Department of Transportation, NHTSA, or other data sources), reference FIG. 1. The physical conditions also include sharp curves, multi-way stops, animal crossings, steep grades, and surface type information.

Obtaining information about the roads 11, 12 requires accessing one or more data source that contains information about the roads and then storing that information for use. To do so the operating software 131 causes the computer server 127 to create a road description database 401, as shown in FIG. 3. The database 401 is then populated by the computer server 127 by accessing Department of Transportation and/or other databases such as Google Maps™ and MapQuest™, and then storing obtained information in the road description database. Ideally, such information is obtained before it is needed so that it is available when needed.

The hazard assessment and warning system 8 also uses weather information. To that end the computer server 127 creates a weather database 422 which is populated with data from the National Weather Service and/or another source(s). In particular, the computer server 127 obtains and stores weather information such as rain, ice, snow, fog, high winds, hail, and sunset and sunrise times.

The operational software 131 also causes the computer server 127 to obtain information regarding the vehicles 14, 15, some of which is obtained from the mobile devices 116, 117 via the hazard system 118. The operating software 131 causes the computer server 127 to create a vehicle information database 414 which stores vehicle information. Such information includes the make, model, age, mileage, prior accident history and history of repairs, if any, and tire conditions, such as age and mileage. This information is initially entered by the drivers 112, 111 into the persistent memories 214 of their mobile devices 116, 117 as directed by the hazard app 118, or into a web-based interface, and then subsequently sent to the computer server 127. Based on the entered vehicle information the computer server 127 obtains a history of design defects and recall histories of the vehicles 14, 15 from the Department of Transportation, NHTSA, manufacturers, and/or other sources.

As drivers 111, 112 can themselves be driving hazards, the hazard assessment and warning system 8 assesses available information about the intended driver 112 and the driver 111. The software 131 causes the computer server 127 to create a driver database 412. Then, the computer server 127 obtains information about the intended driver 112 and the driver 111 from various sources, both internal and external. For example, driver age, medical history, mental state derived from court records (recent divorce, death in family, incarceration of family member), and history of drug, alcohol, and/or tobacco usage are obtained. Such information might be entered by the intended driver 112 or the driver 111 into their mobile devices 116, 117 and then sent to the computer server 127, learned over time as described above, or it might be obtained or confirmed from Department of Motor Vehicles, court records or other source. Since a distracted driver can be dangerous, the computer server 127 also obtains from the mobile devices 116, 117 via the hazard system 118 information regarding current cell phone usage and texting.

Drivers with a record of illegal, improper or dangerous vehicle operation represent an increased safety hazard. The computer server 127 searches the driver's 112, 111 driving records from the Department of Motor Vehicles, court, and other sources to identify indications of driving under the influence, speeding, reckless operation, driving limitations, street racing, excessive speed well above posted speed limits, road rage, tailgating, improper turns, failure to stop, wrong-way driving, unsafe lane changes, running red lights, suspended license and other information. Such information is added to the driver database 412.

While historical driving records are important, both recent and current driving patterns are also important. To that end the processing system 140 creates a driver classification database 416 that stores safety-related driving classifications based on recent and current driving patterns. To that end the mobile devices 116, 117 via the hazard system 118 automatically send location finder 128 and accelerometer 122 data to the processing system 140. Such data is analyzed, for example by applying the data to one or more pre-trained classifiers to produce safety-related driver classifications.

Classifications can relate to speeding, for example determined via a classifier. If the intended driver 112 or the driver 111 is currently driving above the speed limit, which is available from the road description database 401, the processing system 140 can classify that driver as a current speeder, which classification is entered into the driver classification database 416. To that end, location data is preferably automatically sent from the mobile devices 116, 117 via the hazard system 118 to the computer server 127, where velocity data is derived. Alternately, velocity can be directly derived on the mobile devices 116, 117, using location. If a historical pattern of either driver 112, 111 indicates that he/she tends to drive in excess of posted speed limits, that driver can be classified, for example by application of a pre-trained classifier, as being prone to speeding, which classification is entered into the driver classification database 416.

The average speed of vehicles at a particular road location is derived from those vehicles for which speed can be determined, for example using a location finder (e.g. GPS or cell site interpolation), accelerometer, and time, in conjunction with a known road location, to generate data that correlates road, time of day, day of week, day of year with average speed on that known road location with the average speed of vehicles on that road, given these constraints. The speed of driver 112 is compared with the average speed of drivers on that road at the time that driver 112 is driving on that road.

Current street racing and being prone to street racing can be determined based on location and acceleration data from the mobile devices 116, 117 and being on a particular surface road (available from the road description database 401), wherein the processing system 140 classifies that driver as a road racer. Such classification can be made for example by application of a pre-trained classifier specifically trained for determining racing behavior or trained to determine one or more other driving behaviors.

The processing system 140 also determines if one or both of the intended driver 112 and the driver 111 is prone to running red stop lights 30 (see FIG. 1). If the mobile devices 116, 117 via the hazard systems 118 send location and acceleration data to the computer server 127 which indicates that a driver 112, 111 frequently accelerates or travels at a high velocity when approaching a stop light 30 controlled intersection 20, that driver 112, 111 can be classified, for example based on application of a pre-trained classifier, as being prone to running red lights, which classification is stored in the driver classification database 416. Location information is available from location finder 128, acceleration information is available from the accelerometer 122, while stop light 30 controlled intersections 20 are identified from the road description database 401.

The processing system 140 also determines if one or both of the intended driver 112 and the driver 111 is prone to running stop signs 23 (see FIG. 1). If information from the mobile devices 116, 117 via the hazard systems 118 shows that a driver 112, 111 frequently fails to stop at stop signs 23 that driver 112, 111 can be classified, for example based on application of a pre-trained classifier, as being prone to running stop signs, which information is stored in the driver classification database 416. Acceleration information is available from the accelerometer 122 while stop signs 23 are identified from the road description database 401.

The processing system 140 further determines if one or both of the intended driver 112 and the driver 111 is prone to making unsafe lane changes. If so that driver can be classified as being prone to making unsafe lane changes, for example based on application of a pre-trained classifier, which classification is stored in the driver classification database 416. This determination is based on knowledge of the current position of the vehicles 14, 15 on a multi-lane road (identified from the road description database 401) and accelerometer 122 or location finder 128 information from the mobile devices 116, 117.

The processing system 140 further determines if one or both of the intended driver 112 or the driver 111 is currently or is prone to wrong-way driving. If so, that driver is classified, for example based on application of a pre-trained classifier, as either currently driving the wrong-way or as being prone to wrong-way driving, whichever is appropriate. That classification is stored in the driver classification database 416. This classification is based on knowledge of road directions, available from the road description databases 401, and location finder 128 information, available from the mobile devices 116, 117.

The processing system 140 also determines if one or both of the intended driver 112 or the driver 111 is prone to making improper turns such as making left turns from right lanes. If so, that driver is classified, for example based on application of a pre-trained classifier, as being prone to improper turns and that classification is stored in the driver classification database 416. This classification is based on knowledge of road directions, available from the road description databases 401, and location finder 128 information, available from the mobile devices 116, 117 via the hazard systems 118.

The processing system 140 further determines if one or both of the intended driver 112 or the driver 111 currently is or is prone to tailgating. If so, that driver is classified, for example based on application of a pre-trained classifier, as tailgating or as being prone to tailgating and that classification is stored in the driver classification database 416. That determination is based on vehicle proximity and speed, which are determined from location finder 128 information, available from the mobile devices 116, 117 via the hazard systems 118.

The processing system 140 further determines if one or both of the intended driver 112 or the driver 111 is currently experiencing or is prone to road rage. If so, that driver can be classified, for example based on application of a pre-trained classifier, as having road rage or as being prone to road rage and that classification is stored in the driver classification database 416. The road rage determination is based on a combination of speeding, street racing, tailgating, rapid lane changes or weaving as determined using data from the road description database 401 and data available from the mobile devices 116, 117 via the hazard systems 118.

The processing system 140 also determines if either the intended driver 112 or the driver 111 is currently driving recklessly or is prone to reckless driving. If so, that driver can be classified, for example based on application of a pre-trained classifier, as driving recklessly or as being prone to reckless driving and that classification is stored in the driver classification database 416. Such a classification is based on currently or being prone to one or more of speeding, running stop lights, running stop signs, road rage, tailgating, and improper turns as determined using data from the road description database 401 and data available from the mobile devices 116, 117 via the hazard systems 118.

The processing system 140 also determines if either the intended driver 112 or the driver 111 is currently driving or is prone to driving tired, while drowsy, or suffering from narcolepsy. If so, that driver can be classified, for example based on application of a pre-trained classifier, as being driving drowsy or as being prone to driving drowsy, which classification is stored in the driver classification database 416. Such a classification can be based on data available from the mobile devices 116, 117 via the hazard systems 118 that shows a driver 112, 111 is driving slowly, with slow weaving and periodic hard breaking.

FIG. 3 presents a functional operational view of how the computer server 127 implements its part of the hazard assessment and warning system 8. The mobile devices 116, 117 are in bi-directional data communication with an input 304 of the computer server 127. The input 304 also accesses the Internet 188 and other external sources 189. The input 304 feeds information to a processor 305 which analyzes available data to determine if a significant safety hazard exists around the intended driver 112. To that end the processor 305 functionally accesses the road description database 401, the weather database 422, the driver database 412, the vehicle database 414 and the driver classification database 416. If a significant safety hazard exists around the intended driver 112, the processor 305 causes an alert from an alert subsystem 424 to be sent to the intended driver 112.

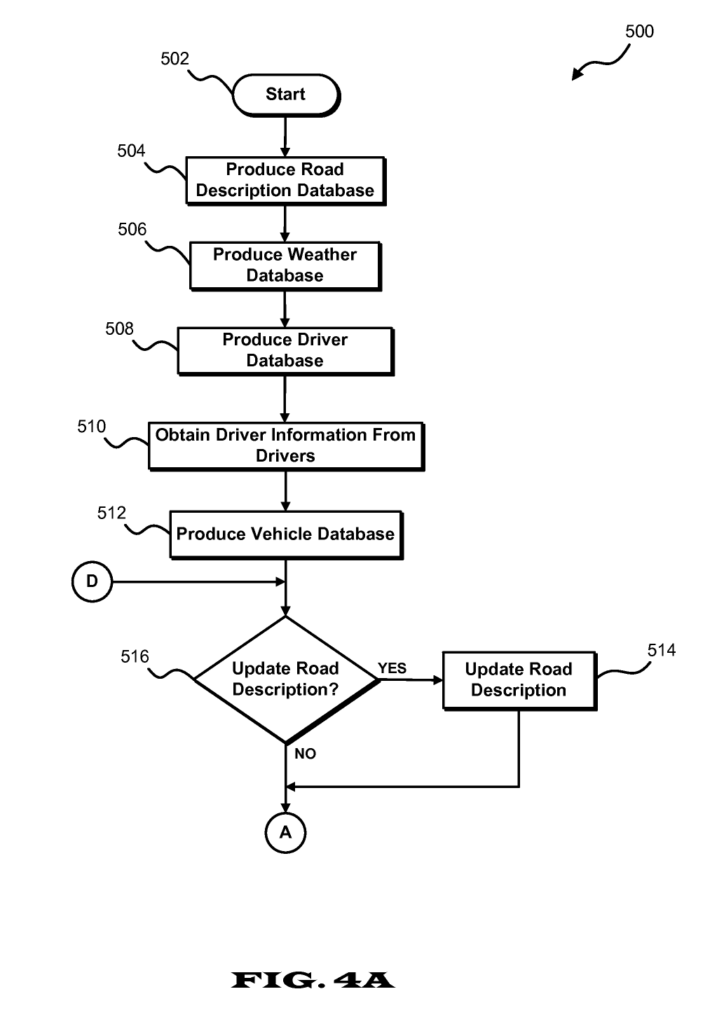

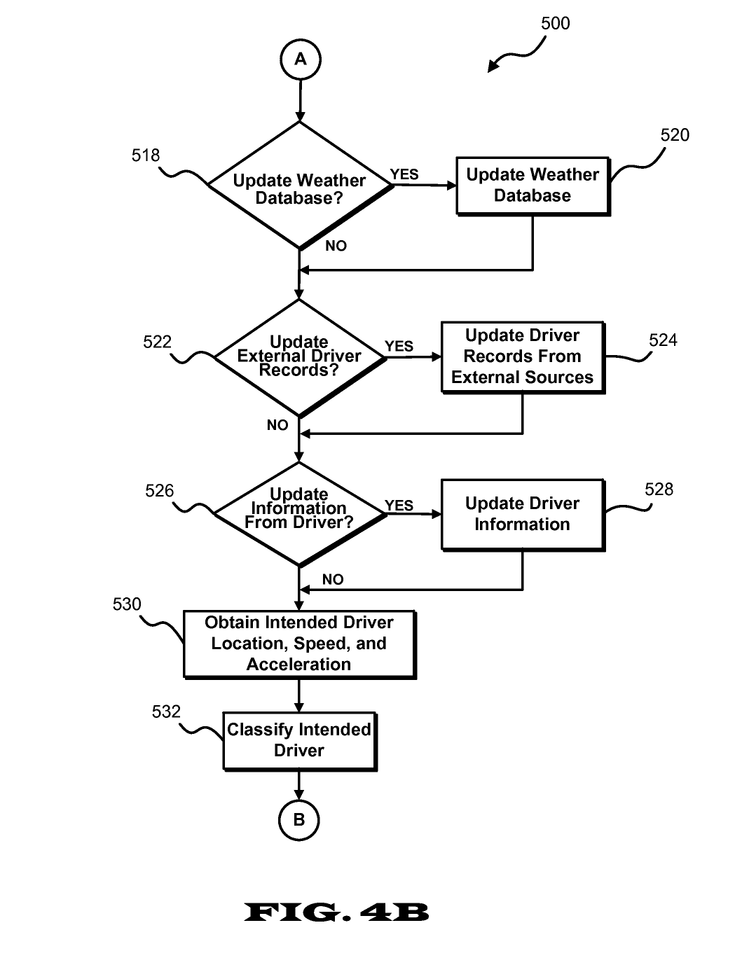

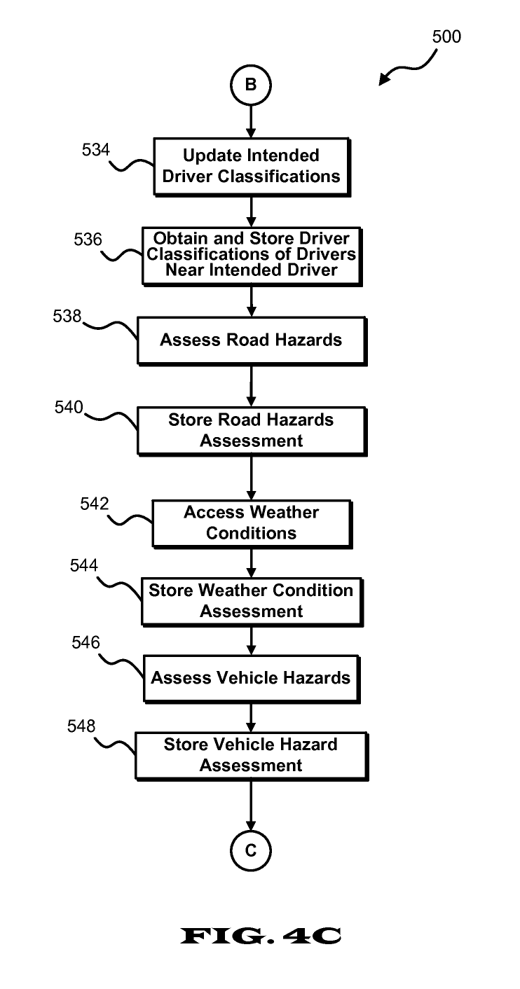

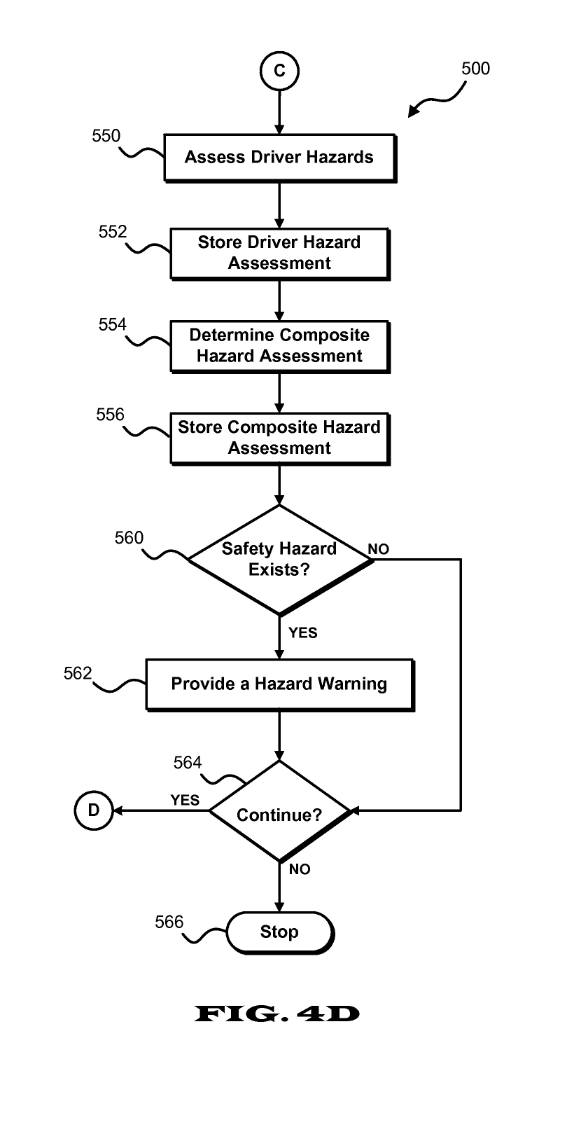

From the foregoing it is apparent that the hazard assessment and warning system 8 operates over a distributed system comprised of multiple devices running in accord with multiple software programs. Those devices and software programs work together to produce the hazard assessment and warning system 8 that implements the overall operation 500 depicted in flow chart form in FIGS. 4A-4D.

The operation 500 begins at step 502, and proceeds with producing the road description database 401 by creating and populating it with road description data as described above, step 504. Then, the weather database 422 is produced by creating and populating it with weather data, step 506 as described above. The operation 500 then produces the driver database 412 by creating and populating it with driver data obtained from external sources (such as a Department of Motor Vehicles), step 508. Information from the drivers 111, 112 is also obtained via the hazard system 118 and stored in the driver database 412, step 510. The vehicle database 414 is then produced and populated with information supplied by the drivers via the hazard system 118 and updated by information from external sources as described above, step 512.

With initial information available, the hazard assessment and warning system 8 enters a main operating loop which includes updating data in the databases to keep them viable. The operation 500 determines if the road description database 401 should be updated, step 516. Data in the road description database 401 is relatively permanent thus updating the road description database 401 is done rather infrequently, about once every two weeks or so. If the determination at step 516 is yes, the road description is updated by recalling data from the road description database 401, step 514.

If the determination at step 516 is no, or after the road description is updated per step 514, the operation 500 determines if the weather database 422 should be updated, step 518. As weather conditions tend to change daily, the weather database 422 is updated at least once a day. If the determination at step 518 is yes, the weather database 422 is updated, step 520.

If the determination at step 518 is no, or after the weather database 422 is updated at step 520, the operation 500 determines if external driver records in the driver database 412 should be updated, step 522. As this information is somewhat dynamic, the external driver records in the driver database 412 are updated every week. If the determination at step 522 is yes, the external driver records are updated, step 524.

If the determination at step 522 is no, or after the external driver records are updated at step 524, the operation 500 determines if information from a driver 111, 112 should be updated, step 526. Such information includes information related to the vehicles 14 and 15 and a driver's medical or other history. As such information is relatively static, the driver-input information is updated every month. If the determination at step 526 is yes, the information from a driver is input and stored in the appropriate database (such as the driver database 412 or the vehicle database 414), step 528.

If the determination at step 526 is no, or after the information from a driver 111, 112 is updated at step 528, the operation 500 proceeds to analyze information to determine if a safety hazard warning should be produced. First, the identification of the intended driver 112 as well as the location, speed, and acceleration of the intended driver 112 are obtained from the mobile device 116, step 530. As previously noted since a mobile device 116 may be operated by any number of different drivers, in step 530 the identification of the specific intended driver 112 is also obtained from the mobile device 116 via the hazard system 118. With that information the current classifications of the intended driver 112 are obtained and stored in the driver classification database 416, step 532. Further, the classifications in the driver classification database 416 for which the intended driver 112 is prone are updated, step 534.

After the intended driver's 112 classifications are updated, the current and historical classifications of the driver 111 or other driver near the intended driver 112 are also obtained and stored, step 536. The current and historical classification of the driver 111 or other driver are obtained and stored responsive to such driver determined as being a predetermined distance from the intended driver 112 and/or traveling in a direction and speed such that is predicted that the actions of such driver may affect the intended driver 112. In making such prediction, a determination can be made of an estimated time of arrival of the mobile device of the intended driver 112 at a present or prospective future location of the other driver(s) (e.g. driver 111) based at least on the current location data including trajectories of the respective mobile devices of the drivers 112, 111.

Following 536 the operation 500 proceeds with assessing road hazards, step 538. This can be performed for example by assigning a numerical quantifier to each large pothole, sharp curve, multi-way stop, and warning (such as animal crossing or pedestrian crossing) in the road description database 401 near the intended driver 112. The numerical quantifier assigned to each potential hazard depends on the design goals of the system designer of operation 500. Then, numerical quantifiers can be assigned based on the accident rate of the road 11 and on road construction along the road 11 (local to the intended driver 112). In selecting road hazards to be quantified, a determination can be made of an estimated time of arrival of the mobile device of the intended driver 112 at a present or future location of the road hazards based at least on the current location data of the mobile device of the driver 112. Obtained numerical quantities can be input to a pre-trained classifier to obtain a measure of the road hazards being encountered by the intended driver 112, which measure is stored as a road hazard assessment, step 540. The pre-trained classifier can be specific to the intended driver 112 and can be frequently retrained using a learning process based on current data. Alternatively, the numerical quantities can be added or processed in other suitable manner to obtain a composite numerical quantifier that acts as the measure of the road hazards being encountered by the intended driver 112.

Following step 540 the operation 500 proceeds with assessing weather conditions, step 542. The operation 500 does this by assigning a numerical quantifier to weather conditions including rain, ice, snow, fog, wind, lightning, time of day, flooding and any other local weather-related conditions. The time of day assessment depends not only on time, but on vehicle headings. For example, a high numerical quantifier is assigned if the driver is driving at night or is heading into a rising or setting sun, determined from the year, day of year, time of day, sunrise and sunset time and location of sun at sunrise/sunset in the weather assessment database, and from the compass 125 or location finder 128 of the mobile device 116. The obtained numerical quantities can be input to a pre-trained classifier to obtain a measure of the weather-related hazards being encountered by the intended driver 112, which measure is stored as a weather condition assessment, step 544. In making such prediction, a determination can be made of an estimated time of arrival of the mobile device of the intended driver 112 at a present or future location of the weather condition based at least on the current location data of the mobile device of the driver 112. The pre-trained classifier can be specific to the intended driver 112 and can be frequently retrained using a learning process based on current data. Alternatively, the obtained numerical quantities can be added together or processed in other suitable manner to obtain a composite numerical quantifier that acts as a measure for weather-related hazards which is stored as the weather condition assessment.

Following step 544 the operation 500 proceeds by assessing vehicle hazards, step 546. The operation 500 does this by assigning a numerical quantifier for the make, model, age, and mileage of the vehicles 14, 15, including the age and mileage of the tires. In addition, a numerical quantifier is assigned as a measure of designed defects, if any, that can be found for the vehicles 14, 15. The obtained numerical quantities can be input to a pre-trained classifier to obtain a measure of the vehicle-related hazard being encountered by the intended driver 112, which measure is stored, step 548. The pre-trained classifier can be trained specific to the respective drivers of the vehicles and/or specific to the driven vehicle and can be frequently retrained using a learning process based on current data. Alternatively, the obtained numerical quantifiers can be added together or processed in other suitable manner to obtain a composite numerical quantifier that acts as a measure for vehicle-related hazards.

Following step 548 the operation 500 proceeds by assigning a driver hazard assessment for the drivers 112 and 111, step 550. The operation 500 does this by assigning a numerical quantifier for each classification in the driver classification database 414 and for the driver's gender, age, health history, mental state, alcohol usage, drug usage, and tobacco usage. The obtained numerical quantities can be input to a pre-trained classifier to obtain a measure of the driver-induced hazards which measure is stored, step 552. The pre-trained classifier can be specific to the respective drivers 112, 111 and can be frequently retrained using a learning process based on current data. Alternatively, the obtained numerical quantifiers can be added together or processed in other suitable manner to obtain and store a composite numerical quantifier that acts as a measure of driver-induced hazards.

The operation 500 proceeds by determining a composite hazard assessment, step 554, which hazard assessment is stored, step 556. The composite hazard assessment is performed by processing the stored road hazard assessment (step 540), the weather condition assessment (step 544), the vehicle hazard assessment (step 548), and the driver hazard assessment (step 552). The composite hazard assessment is a measure of the safety hazards being currently faced by the driver 112. The respective measures of road hazard, weather condition, vehicle hazards, and driver hazards can be applied to a pre-trained classifier, added or processed in other suitable manner to obtain the composite hazard assessment.

Alternatively, the composite hazard assessment can be obtained through application of a pre-trained classifier which receives as input the respective above-described data used in the determination of the road hazard assessment, weather condition assessment, vehicle hazard assessment, and driver hazard assessment. Such pre-trained classifier can be trained specific to the respective drivers of the vehicles and/or specific to the driven vehicle and can be frequently retrained using a learning process based on current data.

A determination is then made as to whether the driver 112 currently faces a significant safety hazard, step 560. This is accomplished by comparing the composite hazard assessment stored in step 556 to a safety trigger value. For example, if the composite hazard assessment is less than the safety trigger value the determination at step 560 is NO, and a jump is made to step 564 (see below). However, if the composite hazard assessment is greater than or equal to the safety trigger value the determination at step 560 is YES, and a hazard warning is produced, step 562.

Following the production of the hazard warning at step 562, of if the composite hazard assessment is less than the safety trigger value, the operation 500 proceeds with a determination of whether the operation 500 will continue, step 564. If yes, the operation 500 returns to step 516. Otherwise the operation 500 stops, step 566.

The foregoing describes an operation 500 in which a composite hazard assessment is determined. The composite hazard assessment can include for example a numeric value compared with a safety trigger value to determine whether a safety hazard exists. The composite hazard assessment can be determined by applying a classifier to data from disparate sources and/or can be is comprised of a combination or summation of a plurality of different assessments, each of which depends on one or more factors. It should be understood that simply one factor, for example a determination that the intended driver 112 may be drunk, can by itself can create a composite hazard assessment that exceeds the safety trigger value resulting in production of a hazard warning. Whereas a plurality of simultaneous conditions, for example determinations that it is night, raining and the vehicle is 20 years old but with good tires, may not be sufficient to exceed a corresponding safety trigger value or result in production of a hazard warning.

Following are non-limiting examples of application of the systems and methods of the invention. Referring now to FIG. 1, an intended driver 112 is stopped at multi-way intersection 20 waiting for a light 30 to change. Another driver 111 having many tickets is approaching the intersection 20 while driving a red, 1966 Chevy SS 396 with a history of accidents. The hazard assessment and warning system 8 determines that the driver 111 has a history of running red lights 30 based upon driving records obtained from the Department of Motor Vehicles, which has recently been confirmed by a driver assessment of the driver 111. The hazard assessment and warning system 8 produces a hazard alarm on the mobile device 116 such that intended driver 112 is informed that a safety hazard exists (specifically that there is a significant likelihood that driver 111 may run the stop light 30 if it turns red.) The intended driver 112 is thus made aware that he should proceed cautiously.

As another example, the intended driver 112 is driving on a road 11 while the hazard assessment and warning system 8 determines that a nearby driver 111, who is driving a blue Prius, has been characterized as having a propensity for driving while distracted. The hazard assessment and warning system 8 produces a warning to the intended driver 112 that a nearby blue Prius may have a driver that is driving distracted. In response and if appropriate the intended driver 112 can take pre-emptive action.

As another example, the hazard assessment and warning system 8 determines that driving conditions have deteriorated due to ice on the road. The intended driver 112 is then informed of the existence of unsafe ice conditions.

In yet another example, the hazard assessment and warning system 8 determines that the intended driver 112 is driving on a local road 11 on which the hazard assessment and warning system 8 has also determined that a street race is in progress on cross road 12. The intended driver 112 is informed of a safety hazard ahead at the intersection 20.

As still another example, the intended driver 112 is driving on a section of road 11 that has a high history of accidents. The intended driver 112 is informed of the history of the local area of road 12.

The hazard assessment and warning system 8 may determine that the intended driver 112 is demonstrating distracted driving behavior. The hazard assessment and warning system 8 then informs the intended driver 112 of his behavior. Similarly, if the hazard assessment and warning system 8 determines that the intended driver 112 is demonstrating reckless driving behavior, the hazard assessment and warning system 8 informs the intended driver 112 that he may be recklessly driving.

While various embodiments of the invention have been described in detail above, the invention is not limited to the described embodiments, which should be considered as merely exemplary. Many modifications and extensions of the invention may be developed, and all such modifications are deemed to be within the scope of the invention defined by the appended claims.

What is claimed is:

1. A processor based method comprising:
accessing current location data of a mobile device corresponding to a first user;
accessing environmental data corresponding to the current location data;
generating a driving condition assessment based on the current location data and the environmental data; and
providing the driving condition assessment to the first user.

2. The processor based method of claim 1, wherein the driving condition assessment comprises a risk assessment corresponding to a road on which the mobile device travels.

3. The processor based method of claim 1, wherein the environmental data comprises a physical road condition, the method further comprising:
determining an estimated time of arrival of the mobile device at a location of the physical road condition based at least on the current location data of the mobile device; and
providing the driving condition assessment with an indication of the physical road condition to the first user a predetermined period of time prior to the estimated time of arrival at the location of the physical road condition.

4. The processor based method of claim 3, wherein the physical road condition comprises at least one of:
a pothole;
a curve;
an intersection;
an animal crossing;
a construction area; and
a location corresponding to an elevated auto accident rate.

5. The processor based method of claim 1, wherein the environmental data comprises a weather condition, the method further comprising:
determining an estimated time of arrival of the mobile device at a location of the weather condition based at least on the current location data of the mobile device; and
providing the driving condition assessment with an indication of the weather condition to the first user a predetermined period of time prior to the estimated time of arrival at the location of the weather condition.

6. The processor based method of claim 5, wherein the weather condition comprises at least one of:
a rain condition;
an ice condition;
a snow condition; and
a fog condition.

7. The processor based method of claim 1, further comprising:
determining ambient lighting corresponding to a current time of day; and
generating the driving condition assessment further based on the determined ambient lighting.

8. The processor based method of claim 1, further comprising:
accessing descriptive data of a motor vehicle corresponding to the first user; and
generating the driving condition assessment further based on the motor vehicle descriptive data.

9. The processor based method of claim 8, wherein the motor vehicle descriptive data comprises at least one of the motor vehicle:
make;
model;
age;
mileage;
predetermined design defects;
maintenance history;
tire age; and
tire distance traveled.

10. The processor based method of claim 1, further comprising:
accessing current speed data of a mobile device corresponding to the first user; and
generating the driving condition assessment further based on the current speed data of the mobile device.

11. The processor based method of claim 10, further comprising:
determining a speed limit corresponding to a road corresponding to the current location;
comparing the current speed data with the speed limit; and
generating the driving condition assessment further based on the comparison of the current speed data with the speed limit.

12. The processor based method of claim 1, further comprising:
accessing driving history data corresponding to the first user; and
generating the driving condition assessment further based on the driving history data.

13. The processor based method of claim 1, further comprising
accessing predetermined sensor data corresponding to the mobile device;
predicting a driver skill level of the first user based on the predetermined sensor data; and
generating the driving condition assessment further based on the predicted driver skill level.

14. The processor based method of claim 13, wherein the predetermined sensor data comprises at least one of location data generated via the mobile device and location data generated through cell site interpolation.

15. The processor based method of claim 13, wherein the predetermined sensor data comprises predetermined location data and predetermined velocity data generated via the mobile device.

16. The processor based method of claim 13, wherein the predetermined sensor data comprises predetermined location data, predetermined velocity data, and predetermined acceleration data generated via the mobile device.

17. The processor based method of claim 13, the method further comprising accessing map data corresponding to the predetermined location data, wherein predicting the driver skill level comprises comparing the predetermined sensor data and the map data.

18. The processor based method of claim 17, wherein the predetermined sensor data comprises at least one of:
predetermined location data;
predetermined velocity data; and
predetermined acceleration data;
wherein the map data comprises at least one of:
indications of traffic intersections;
indications of traffic signs; and
indications of traffic signals;
and wherein comparing the predetermined sensor data with the map data comprises determining at least one of the velocity and acceleration of the mobile device at or a predetermined distance from a corresponding traffic intersection, traffic sign, or traffic signal based on the predetermined sensor data.

19. The processor based method of claim 17, wherein the predetermined sensor data comprises at least one of:
predetermined location data;
predetermined speed data; and
predetermined acceleration data;
wherein the map data comprises rule definitions comprising at least one of:
indications of road directional restrictions;
indications of lane configurations;
indications of traffic intersections;
indications of traffic signs; and
indications of traffic signals;
and wherein predicting the driver skill level comprises predicting if a vehicle in which the mobile device travels has adhered to the rule definitions based on the comparison of the predetermined sensor data and the map data.

20. The processor implemented method of claim 1, further comprising:
accessing data comprising at least one of a gender of the first user, an age of the first user, and an indication of the health of the first user; and
generating the driving condition assessment further based on the at least one of the gender of the first user, the age of the first user, and the indication of the health of the first user.

21. The processor implemented method of claim 1, further comprising:
accessing current location data of a mobile device corresponding to a second user;
comparing the current location data of the mobile device corresponding to the first user and the current location data of the mobile device corresponding to the second user; and
generating the driving condition assessment further based on the comparison of the current location data of the mobile device corresponding to the first user and the current location data of the mobile device corresponding to the second user.

22. The processor based method of claim 21, further comprising:
accessing driving history data corresponding to the second user; and
generating the driving condition assessment further based on the driving history data corresponding to the second user.

23. The processor based method of claim 21, further comprising:
accessing predetermined sensor data corresponding to the mobile device corresponding to the second user;
predicting a driver skill level of the second user based on the predetermined sensor data; and
generating the driving condition assessment further based on the predicted driver skill level of the second user.

24. The processor implemented method of claim 21, further comprising:
accessing current sensor data comprising the current location data and at least one of current velocity data and current acceleration data corresponding to the second user;
applying a classifier to the current sensor data corresponding to the second user;
generating the driving condition assessment further based on the application of the classifier to the current sensor data corresponding to the second user.

25. The processor implemented method of claim 21, further comprising:
accessing current sensor data comprising the current location data and at least one of current velocity data and current acceleration data corresponding to the first user;
accessing current sensor data comprising the current location data and at least one of current velocity data and current acceleration data corresponding to the second user;
determining based on the current sensor data corresponding to the first and second users that the second user is on a trajectory corresponding to a prospective future location of the first user; and
generating the driving condition assessment further based on the determined trajectory of the second user.

26. The processor implemented method of claim 25, further comprising:
determining based on the current sensor data corresponding to the second user that the second user is driving in an unsafe manner; and
generating the driving condition assessment further based on the determination that the second user is driving in an unsafe manner.

27. The processor implemented method of claim 21, further comprising:
accessing driving history data corresponding to the second user;
determining based on the driving history data that the second user is at risk to drive in an unsafe manner; and
generating the driving condition assessment further based on the determination that the second user is at risk to drive in an unsafe manner.

28. The processor implemented method of claim 21, further comprising:
accessing current sensor data and driving history data corresponding to the second user;
determining based on at least one of the current sensor data and the driving history data that the second user is on a trajectory corresponding to a prospective future location of the first user and that the second user is at risk to drive in an unsafe manner; and
generating the driving condition assessment further based on the determination that the second user is on a trajectory corresponding to a prospective future location of the first user and that the second user is at risk to drive in an unsafe manner.

29. The processor implemented method of claim 28, wherein the current sensor data corresponding to the second user comprises at least one of current acceleration data, current velocity data, and the current location data of the mobile device corresponding to the second user.

30. The processor implemented method of claim 21, further comprising:
training a classifier based on predetermined sensor data specific to a type of vehicle driven by the second user;
accessing current sensor data corresponding to the second user;
applying the classifier to the current sensor data corresponding to the second user; and
generating the driving condition assessment further based on the application of the classifier to the current sensor data corresponding to the second user.

31. The processor implemented method of claim 1, further comprising:
training a classifier based on predetermined sensor data specific to a type of vehicle driven by the first user;
accessing current sensor data corresponding to the first user; and
applying a classifier to the current sensor data to generate the driving condition assessment.

32. A driving hazard assessment and warning system, comprising:
a first mobile device having communications capabilities and producing first user location data, wherein the first user location data corresponds to a road;
a road description database comprising data corresponding to the road;
a computer input receiving the first user location data;
an alert subsystem; and
a processor operatively connected to the road description database, to the alert subsystem, and to the computer input;
wherein the processor uses the first user location data to access a description of the road from the road description database;
wherein the processor analyzes the obtained description of the road to identify a substantial safety hazard; and
wherein the processor causes the alert subsystem to output a warning if the processor identifies a substantial safety hazard.

33. The driving hazard assessment and warning system according to claim 32, further comprising weather data operatively input to the processor, and
wherein the processor analyzes the weather data to identify a substantial safety hazard.

34. The driving hazard assessment and warning system according to claim 33, wherein the weather data is operatively input to the processor from a weather database.

35. The driving hazard assessment and warning system according to claim 33, wherein weather data comprises data corresponding to at least one of the following: rain, ice, snow, fog, time of day, sunrise time, sunset time, sleet, ambient light.

36. The driving hazard assessment and warning system according to claim 32, further comprising a vehicle database operatively connected to the processor,
wherein the processor identifies a first vehicle based on the first mobile device;
wherein the processor uses the first vehicle to access a description of the first vehicle from the vehicle database; and
wherein the processor analyzes the description of the first vehicle to identify a substantial safety hazard.

37. The driving hazard assessment and warning system according to claim 36, wherein the vehicle database comprises data corresponding to at least one of the following: make, model, age, mileage, design defects, tire age, and tire mileage of the first vehicle.

38. The driving hazard assessment and warning system according to claim 32, wherein the processor creates a driver classification database, populates the driver classification database with at least one classification of the first user, and uses the driver classification database to identify a substantial safety hazard.

39. The driving hazard assessment and warning system according to claim 38, wherein the least one classification of the first user is that the first user is prone to speeding, drunk driving, driving while distracted, reckless driving, running red lights, running stop signs, driving the wrong direction, unsafe lane changes, tailgating, improper turns, road rage, drowsy driving, and street racing.

40. The driving hazard assessment and warning system according to claim 32 wherein the road description database comprises data corresponding to at least one of the following: a pothole, a sharp curve, a multi-way stop, an animal crossing, road construction, and a high accident rate.

41. The driving hazard assessment and warning system according to claim 32, further comprising a second mobile device having communications capabilities and producing second user location data, wherein the second user location data corresponds to a second road;
wherein the computer input receives the second user location data; and
wherein the processor receives and analyzes the second user location data to determine if the second user presents a substantial safety hazard.

42. The driving hazard assessment and warning system according to claim 41, wherein the processor analyzes the first user location data and the second user location data to determine if there is a substantial crash hazard.

43. The driving hazard assessment and warning system according to claim 42, wherein the processor uses the second mobile device to obtain a description of the second vehicle from the vehicle database, and wherein the processor analyzes the description of the second vehicle to identify a substantial safety hazard.

44. The driving hazard assessment and warning system according to claim 32, further comprising a driver database operatively connected to the processor,
wherein the processor identifies a first user based on the first mobile device;
wherein the processor uses the first user identification to access a description of the first user from the driver database; and
wherein the processor analyzes the description of the first user to identify a substantial safety hazard.

45. The driving hazard assessment and warning system according to claim 44, wherein the driver database comprises data corresponding to at least one of the following: age of the first user, gender of the first user, health of the first user, tobacco usage, alcohol usage, drug usage of the first user.

46. The driving hazard assessment and warning system according to claim 44, further comprising a second mobile device having communications capabilities and producing second user location data, wherein the second user location data corresponds to a second road;
wherein the computer input receives the second user location data;
wherein the processor receives and analyzes the second user location data to determine if the second user presents a substantial safety hazard; and
wherein the driver database comprises second user data corresponding to at least one of the following: age of the second driver, gender of the second driver, health of the second driver, tobacco usage, alcohol usage, drug usage of the second driver and wherein the processor analyzes the second driver data to identify a substantial safety hazard.

47. The driving hazard assessment and warning system according to claim 46, wherein the driver classification database comprises at least one classification of the second user.

48. The driving hazard assessment and warning system according to claim 47, wherein the least one classification of the second user is that the second user is prone to speeding, drunk driving, driving while distracted, reckless driving, running red lights, running stop signs, driving the wrong direction, unsafe lane changes, tailgating, improper turns, road rage, drowsy driving, and street racing.
